(19) United States
(12) Patent Application Publication
(10) Pub. No.: US 2024/0068118 A1
(43) Pub. Date: Feb. 29, 2024

(54) SYSTEMS AND METHODS FOR PRODUCTION OF HYDROGEN AND OXYGEN

(71) Applicant: ASTRON AEROSPACE LLC, DERBY, KS (US)

(72) Inventor: MATTHEW T. RILEY, WICHITA, KS (US)

(21) Appl. No.: 18/229,879

(22) Filed: Aug. 3, 2023

Related U.S. Application Data
(60) Provisional application No. 63/395,319, filed on Aug. 4, 2022.
(60) Provisional application No. 63/415,208, filed on Oct. 11, 2022.
(60) Provisional application No. 63/526,901, filed on Jul. 14, 2023.

(51) Int. Cl. C25B 15/08; C25B 1/04; C25B 9/015; C25B 9/05; C25B 9/17

(52) U.S. Cl. CPC C25B 15/083; C25B 1/04; C25B 9/015; C25B 9/05; C25B 9/17

(57) ABSTRACT

A hydrogen and oxygen gas production system, parts thereof, and methods associated therewith is provided. The system utilizes naturally occurring fissures on the ocean floor which expel superheated water at a high pressure. The system includes a bell shaped device attached to a tube, included within the bell is an electrolysis device, including a cathode/anode combination. The bell shaped device catches water expelled from the fissure and the electrolysis device pulls the water molecules apart into their individual components in their gaseous form, hydrogen and oxygen. The gasses then travel up the tube to an end of the tube located above sea level, wherein the gasses are separated from one another utilizing either their natural properties or a selectively permeable membrane. The system further provides a method for collecting the separated gasses from the tube and storing them in compressed tanks in a usable form.

### CROSS-REFERENCE TO RELATED APPLICATIONS

This application claims the benefit of U.S. Provisional Patent Application Ser. No. 63/395,319 filed on Aug. 4, 2022, U.S. Provisional Patent Application Ser. No. 63/415,208 filed on Oct. 11, 2022, and U.S. Provisional Patent Application Ser. No. 63/526,901 filed on Jul. 14, 2023, the disclosures of which are incorporated in their entirety herein by reference.

### FIELD OF THE INVENTION

The present invention relates generally to production of hydrogen and oxygen. More specifically, the present invention relates to devices, systems and methods for use in the separation of hydrogen and/or oxygen from water and collection/storage of the same.

### BACKGROUND OF THE INVENTION

Hydrogen is a basic element (consisting of only one proton and one electron) that is capable of storing and delivering usable energy. Unfortunately, hydrogen does not typically exist by itself in nature, and therefore must be produced from compounds that contain it.

Hydrogen currently is produced using a number of different processes, including: thermochemical processes that use heat and chemical reactions to release hydrogen from organic materials (such as fossil fuels and biomass); through biological processes that use bacteria or algae; or from electrolytic or photolytic processes that split water into hydrogen and oxygen using electrolysis or solar energy. Microorganisms such as bacteria and algae can produce hydrogen through biological processes.

Electrolytic and photolytic processes are both promising options of hydrogen production due to their potential to utilize renewable energy sources in the production. Electrolysis is the process of using electricity to split water into hydrogen and oxygen. This reaction typically takes place in a unit called an electrolyzer, which consist essentially of an anode and a cathode separated by an electrolyte. Generally, hydrogen gas is formed at the cathode, and oxygen is formed at the anode. Photolytic processes utilize sunlight and specialized photoelectrochemical semiconductors to energize the electrolysis process to split water into hydrogen and oxygen.

Existing processes for product of hydrogen all have their strengths and weaknesses. For example, many electrolyzers, such as solid oxide electrolyzers, are required at extremely high temperatures to function properly (about 700°−800° C., or for some advanced lab-scale solid oxide electrolyzers 500°−600° C.). In addition high pressures are typically required to break the electron bond in water. This is often an expensive, inefficient process.

Therefore, it is desirable to provide devices, systems and methods for use in the separation of hydrogen and oxygen from water and collection/storage of the same that overcome some or all of the disadvantages of the processes of the prior art.

### SUMMARY OF THE INVENTION

The instant invention provides devices, systems and methods for use in the separation of hydrogen and oxygen from water and collection/storage of the same. A system of some embodiments of the present invention includes a bell-shaped device connected to a tube. The bell is lowered under water with the opposing end of the tube open to atmospheric pressure. As such the bell (and portion of tube below the water line) is filled with water when placed under water. The bell is placed above a fissure at the bottom of the ocean, out of which superheated water discharges. The superheated water and high pressure below the ocean are an ideal environment for electrolysis or photo-electrolysis. Electrolytic and/or photolytic processes (referred to herein collectively as “electronlytic” or “electrolysis”) are initiated within the bell to separate the oxygen and hydrogen from the water. The hydrogen and oxygen gas then float up from the bell through the tube to a collection/storage system located above the surface of the water (e.g. on a boat or other suitable platform).

In some embodiments, the bell includes at least one anode and at least one cathode.

In some embodiments, the tube includes two or more sub-tubes, with one separate tube channeling oxygen from the anode and another separate tube channeling hydrogen from the cathode.

In some embodiments either an anode or a cathode are located near the center of the bell, with the other (e.g. if anode in center, then cathode is the “other”, or vice versa) near or at the circumference of the bell. In some such embodiments, the other anode/cathode is positioned on the outside of the bell. In some embodiments, the bell is made of an electron conductive material.

In some embodiments, a membrane is positioned in the tube. The membrane allows smaller hydrogen molecules to pass therethrough continuing up the tube to a hydrogen storage tank on a boat, platform or on shore, while preventing the larger oxygen molecules from passing. In some embodiments, a bypass tube is positioned below the membrane to allow oxygen (and/or other particles within the water) (that is blocked by the membrane) to bleed off and/or be collected in an oxygen storage tank located on a boat, platform or on the shore. In some embodiments, the bypass tube includes a trap (similar to a p-trap) to prevent hydrogen from entering the oxygen bypass tube and storage tank. In some embodiments a membrane is utilized without an oxygen bypass. In such embodiments, the oxygen gas will eventually escape (bleed off) at the bottom of the tube, out of the bell. It will be appreciated that the location of the membrane and location of the bypass tube (if utilized) of various embodiments of the present invention will be varied depending upon the desired results as well as the environmental variables in which the collection process is taking place.

In some embodiments of the present invention, in which a membrane is not utilized, the collection tube is closed at the storage tank end by a valve while hydrogen is being produced. As the hydrogen and oxygen fill the tube and more hydrogen/oxygen are produced/extracted, the hydrogen will eventually fill the entire tube and bell and force all the oxygen to bleed out of the bottom of the tube/bell.

In embodiments of the present invention, the hydrogen that has been separated/collected in the tube of the present invention compresses itself naturally as it rises from underneath the ocean and compresses itself by nature into a hydrogen storage tank.

It will be appreciated that embodiments of the present invention included various alternative configurations of anodes and/or cathodes, as well as other various electrolytic and/or photolytic processes conducted within the structure of the present invention to accomplish the separation of hydrogen and/or oxygen from the water. In different embodiments varying voltages, frequencies, amperages, amplitudes, modulation, ac/dc currents, are utilized to initiate the separation processes. Likewise, various embodiments of the present invention utilize various alternative energy sources, including traditional sources, as well as solar, static charge, etc. Varying embodiments utilize varying combinations and amounts of depth, pressure, and/or heat, depending upon the location and environment in which the process is being utilized.

In some embodiments, the pressure at the location of the bell is at least 100 psi.

In some embodiments of the present invention, the pipe structure of the present invention is utilized to push/pump fresh water, gases or other materials down from above the water surface to a location below the water surface (e.g. to the ocean floor). In some such embodiments, the materials are used in a process in which high pressure under water and/or high heat at a fissure are desirable for molecular bonding or other actions on the materials at high pressure and/or high heat.

In some embodiments, the outer shell of tube near the collection point defines one or more spickets branching off from the main tube. In some embodiments, the spickets are configured to attach to one or more corresponding collection tanks of collection system. In some embodiments, the spickets are configured to be open to the atmosphere. In some embodiments, the one or more spickets include a valve configured to stop the flow of gas from the interior volume of the tube into the collection system, thereby controlling the flow.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth herein and is shown in the drawings/exhibits.

FIG. 1 shows a schematic of a system of an embodiment of the present invention.

FIG. 2 shows a schematic view of a system of another embodiment of the present invention that includes a membrane within the tube. The membrane allows smaller hydrogen molecules to pass therethrough continuing up the tube to a hydrogen storage tank on a boat, platform or on shore, while preventing the larger oxygen molecules from passing. In the embodiment shown, the larger oxygen molecules are collected through a bypass tube that leads to an oxygen storage tank on a boat, platform, or on the shore, or may lead back into the water or atmosphere if oxygen collection is not desired.

FIG. 3 shows a schematic view of a system of another embodiment of the present invention that includes two spickets branching off from the main tube. In this embodiment, the hydrogen collects in the top spicket and the oxygen collects in the lower spicket.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

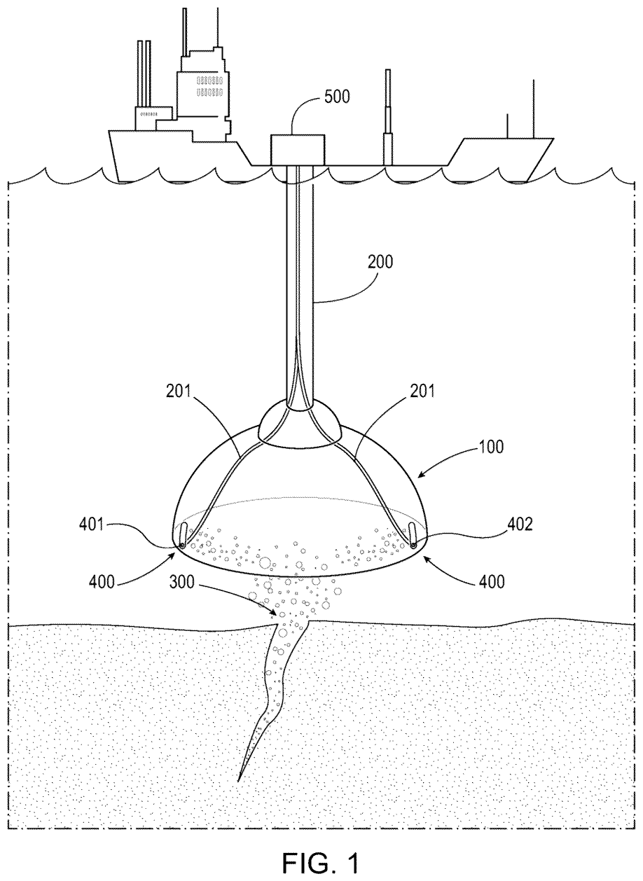

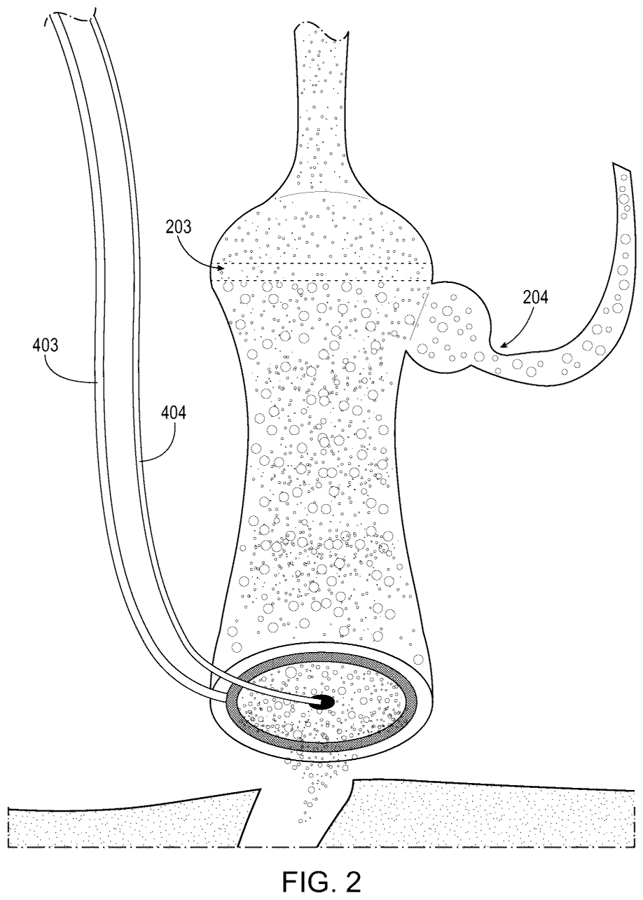

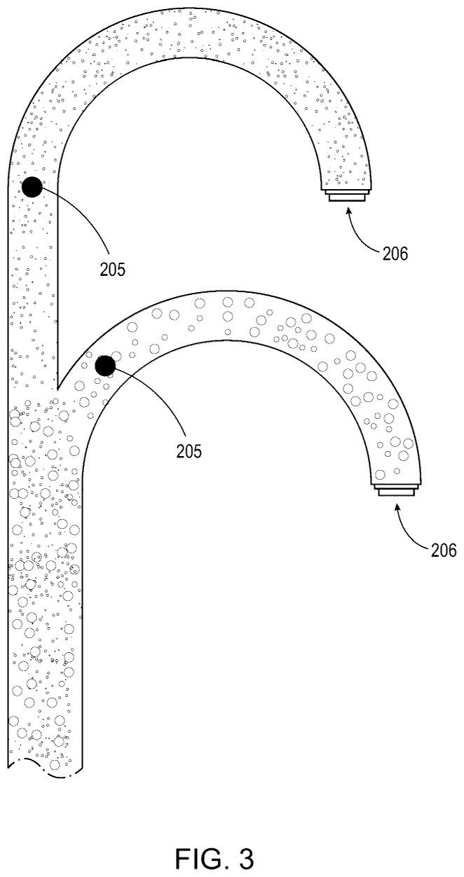

Referring to FIGS. 1-3, some embodiments of the present invention include a bell 100 defining opposed first and second ends and an outer shell extending therebetween. In some embodiments, the outer shell of the bell defines an inner volume, and the first end of the bell defines an inlet to receive a flowing fluid and the second end defines an outlet. In some embodiments, the inlet and the outlet define circular apertures. In some such embodiments, the aperture of the inlet defines a larger diameter than that of the aperture of the outlet. It will be appreciated that, various embodiments of the present invention include different shapes and sizes of the apertures of the inlet and outlet and combinations thereof, as would be readily understood by those having ordinary skill in the art.

In some embodiments, the outer shell of the bell 100 is made of a material capable of conducting electrons. It will be appreciated that embodiments of the present invention include various different materials for the outer shell of the bell. In some embodiments the outer shell of the bell is a plastic material. In some embodiments the outer shell of the bell is a metal material.

In some embodiments, the flowing fluid received by the inlet is water which is expelled by a fissure 300. In some embodiments, the fissure is a volcanic fissure. In some embodiments, the fissure is a hydrothermal vent. In some embodiments, the fissure is naturally occurring. In some embodiments, the fluid expelled by the fissure is superheated. In some embodiments the fluid is expelled at least at approximately 374° C. It will be appreciated that embodiments of the present invention include various means of expelling superheated fluid and temperatures thereof. In some embodiments, the fissure is located on the ocean floor at a depth where the fluid expelled from the fissure is at a high pressure. In some of such embodiments, the fissure is located more than 2000 meters below sea level, wherein the pressure of the water is more than approximately 3,200 psi. It will be appreciated that embodiments of the present invention include fluid that is expelled at a variety of temperatures and pressures which occur either naturally or unnaturally.

In some embodiments, the bell 300 includes electrolysis device 400 including a cathode 401 and an anode 402. In some such embodiments, the electrolysis device further includes a cathode power wire 403 and an anode power wire 404 configured to provide energy to the cathode and anode respectively. In some embodiments, the anode or cathode is positioned at the center of the inlet, with the other anode/cathode being positioned on the outer shell of the bell. In some embodiments, the other anode/cathode is positioned on the exterior of the outer shell of the bell. In some embodiments, both the anode and cathode define opposed positions, each on the outer shell of the bell. In some embodiments, the anode and the cathode are positioned nearer the inlet, thereby being located at the beginning of the flow path. It will be appreciated that embodiments of the electrolysis device include various different materials for the anode and cathode. In some embodiments, the cathode and anode are made of different materials. In some embodiments the cathode and anode are made of the same material. In some embodiments the cathode and anode are made of metal. In other embodiments the cathode and anode are made of nonmetals such as graphite. In some embodiments, the cathode and anode are made of platinum.

In some embodiments of the present invention, the electrolysis device is configured to separate different elements that make up the flowing fluid. In such embodiments where the flowing fluid is water, the electrolysis device is configured to separate hydrogen from oxygen, upon which, the hydrogen and oxygen will exist in their gaseous forms. In some such embodiments, this separation of hydrogen and oxygen is achieved by means of electrolysis, whereby the flowing water is pulled apart, the hydrogen being pulled towards the cathode, and the oxygen being pulled toward the anode. In some such embodiments, this electrolysis is powered by a direct current provided to the anode and cathode respectively.

It will be appreciated that embodiments of the electrolysis device include various alternative configurations of anodes and/or cathodes, as well as other various electrolytic and/or photolytic processes conducted within the structure of the present invention to accomplish the separation of hydrogen and/or oxygen from the water. In different embodiments varying voltages, frequencies, amperages, amplitudes, modulation, ac/dc currents, are utilized to initiate the separation processes. Likewise, various embodiments of the present invention utilize various alternative energy sources, including traditional sources, as well as solar, static charge, etc. Varying embodiments utilize varying combinations and amounts of depth, pressure, and/or heat, depending upon the location and environment in which the process is being utilized. In some embodiments the electrolysis device is a static electrolyzer. In some embodiments, the electrolysis device is a direct current electrolyzer. In some embodiments, the electrolysis device is a microwave electrolyzer.

Some embodiments of the present invention include a tube 200 having opposed top and bottom ends and an outer shell extending therebetween. In some embodiments, the bottom end of the tube 200 is connected to the second end of the bell at one or more connection points and the top end of the tube 200 attaches to some collection system 500 at one or more collection points. In some embodiments, the outer shell of the tube 200 defines an interior volume that is configured to facilitate and direct flow of the hydrogen and oxygen through the tube. In some embodiments the shape and size of the outer shell of the tube 200 at the connection point corresponds to that of the outlet of the bell. It will be appreciated that various configurations of the connection point are included in the present invention which affix the bottom end of tube 200 to the second end of the bell. In some embodiments, the connection point is such that the outer shell of tube 200 forms a continuous shell with the outer shell of the bell. In other embodiments the connection point includes a clamp securing the tube to the bell which, in some embodiments, is optionally releasable, thereby separating the tube and the bell. In some embodiments in which the tube and the bell are both metal, the connection point is defined by welding the bell and the tube together.

It will be appreciated that embodiments of the present invention include various different materials for the outer shell of the tube. In some embodiments the outer shell of the tube is a plastic material. In some embodiments the outer shell of the tube is a metal material. In some embodiments, the outer shell of the tube is the same material as that of the outer shell of the bell. In some embodiments the outer shell of the tube is a rigid material. In some of such embodiments the outer shell of the tube includes one or more break lines which allow the tube to move between an operational configuration where the tube is put together for use and a knockdown configuration where the tube is in a more condensed form for storage. In some embodiments, the outer shell of the tube is a flexible material such as a hose, which is adapted to be manipulated for easier storage.

In some embodiments, the inner volume of tube contains one or more sub tubes 201 that extend through the outlet of the bell into the interior volume of the bell. In some of such embodiments, the tube contains two sub tubes 201, one of which being configured to collect the oxygen and transport it from the bell 300 to the upper end of the tube, the other of which being configured to collect the hydrogen and transport it from the bell to the upper end of the tube.

In some embodiments, the inner volume of tube contains one or more membranes 203 which separate the inner volume of tube into two segments, one segment being superior to the membrane, the other being inferior to the membrane. In some of such embodiments, the membrane is configured so as to only be permeable by hydrogen gas. It will be appreciated that the present invention includes various configurations of membranes that are permeable by only hydrogen gas, such as a membrane comprising pores of a size which, in some embodiments, are larger than hydrogen gas molecules but smaller than oxygen gas molecules. In other embodiments, the membrane's 203 selective permeability is achieved by differentiating hydrogen from other molecules based on hydrogen's inherent diffusion coefficient.

In some embodiments, there exists a bypass valve attached to the inferior segment of the tube, allowing oxygen or other non-hydrogen gases to escape out of the inner volume of the tube. In some embodiments, the bypass valve further includes a trap 204 which is configured to not allow hydrogen gas to enter the bypass valve, in some embodiments this trap defines a p-trap. In some embodiments this trap defines a membrane configured to be permeable for other gasses present in the interior volume of the tube other than hydrogen. In some embodiments, the bypass valve is defined by the shape of the outer shell of the tube. In other embodiments, wherein there is no bypass valve, oxygen and other gasses will seep out of the bottom end of the bell naturally as the inner volume of tube fills with hydrogen gas due to the gas' relative density.

In some embodiments, the collection system 500 comprises one or more tanks, configured to connect to the upper end of the tube at the collection point and be filled with one or more of the gasses from the interior volume of tube. In some embodiments, at least one of the tanks of collection system 500 is a tank configured for storage of compressed hydrogen. It will be appreciated that various embodiments of the invention use commonly known collection systems such as a containers, tanks, barrels, casks, cistern, or similar such means for collecting and storing a gas.

In some embodiments, the outer shell of tube near the collection point defines one or more spickets 206 branching off from the main tube. In some embodiments, the spickets are configured to attach to one or more corresponding collection tanks of collection system 500. In some embodiments, the spickets are configured to be open to the atmosphere. In some embodiments, the one or more spickets include a valve configured to stop the flow of gas from the interior volume of the tube into the collection system 500, whereby stopping the flow for an amount of time allows the entire interior volume of the tube to fill with hydrogen gas, any other gas seeping out of the bell inlet. In some embodiments, the individual one or more spickets are configured to fill with only one kind of gas within the inner volume of tube. It will be appreciated that the present invention includes various different combinations and configurations of spickets to enable them to fill with only one type of gas.

In some embodiments, there are two spickets, one located above the other, wherein the upper spicket fills with hydrogen gas and the lower spicket fills with another gas such as oxygen naturally due to the relative densities of the gasses. In some embodiments, there is only one spicket attached to the superior segment of the tube, thereby only filling with gasses that are capable of permeating the membrane 203 (e.g. hydrogen). In some embodiments, there are two spickets, one is attached to the superior segment of tube, and one is attached to the inferior segment of tube in which, in some embodiments, the spicket attached to the inferior segment of tube forms a bypass valve of the embodiments discussed herein. In some embodiments, each spicket corresponds to one or more sub tubes 201 of the embodiments discussed herein. In some embodiments the spickets are approximately an inverted U-shape such that the hydrogen and oxygen collect at the top of their respective spicket. In some embodiments, valves are placed at the entrance to one or both spickets. In some embodiments, valves are placed at the end of one or both spickets.

In some embodiments, each spicket further comprises one or more sensors 205, each sensor being configured to detect the presence of one or more different gasses. In some of such embodiments, there is one sensor located in a spicket containing hydrogen gas to detect the gas's presence, furthermore, in some embodiments, the sensor also detects the purity of the gas within the spicket. In some of such embodiments, the sensor detects the purity of the hydrogen gas by sensing whether other gasses are present within the spicket. In some embodiments, there is a second sensor located in the second spicket which detects the presence and purity of oxygen or another kind of gas which is not hydrogen. It will be appreciated that various different embodiments of configurations and combinations of the sensors are included in the present invention, some of such embodiments have the sensors located not in the spickets themselves, but instead in the interior volume of the tube. In some embodiments, the sensors are located within the bell. In some embodiments, the sensors are placed at the top of the curve of the inverted U-shape of the corresponding spicket.

In some embodiments, the pipe structure of the present invention is of a sufficient size and length that it is positioned in a manner wherein the bottom end of the bell is located directly above a naturally occurring fissure on the floor of the ocean which creates a flow of superheated water at a high pressure, whereby the bell, in some embodiments, receives some or all of the water flowing from said fissure. In some of such embodiments, the flowing water, when passing the electrolysis device 400, separates into its individual component elements, hydrogen and oxygen, in their gaseous form, which flows from the bell, through the interior volume of tube and into the collection system 500. In some embodiments, the pipe structure of the present invention is further positioned such that the upper end of tube is exposed to atmospheric pressure and, in some embodiments, the collection system 500 is located on a boat. It will be appreciated that various embodiments of the positioning of the collection system 500 are included in the present invention, such as on nearby land, on a platform, and in other ways which can be understood by those having ordinary skill I the art. In one exemplary embodiment, the hydrogen is stored in a tank of collection device 500 and the oxygen is released to the atmosphere.

In some embodiments of the present invention, the pipe structure of the present invention is utilized to push/pump fresh water, gases or other materials down from above the water surface to a location below the water surface (e.g. to the ocean floor). In some such embodiments, the materials are used in a process in which high pressure under water and/or high heat at a fissure are desirable for molecular bonding or other actions on the materials at high pressure and/or high heat.

Embodiments of the present invention also include a method of producing hydrogen and oxygen gas from water utilizing naturally occurring superheated water under high pressures, thereby saving energy that would otherwise be needed to increase the pressure and temperature of water. In some embodiments, the inventive method includes a user positioning embodiments of the pipe structure of the present invention above a fissure on the deep ocean floor which naturally expels superheated water. In some embodiments, the location and various conditions of the fissure are such that the water expelled from the fissure is in a supercritical phase, thereby decreasing the amount of energy needed to power electrolysis of the water. In some embodiments, the method includes collecting hydrogen produced by the pipe structure of the present invention in a tank suitable for hydrogen storage. In some embodiments the method includes collecting oxygen produced by the pipe structure of the present invention in a tank suitable for oxygen storage. In some embodiments, the method includes allowing oxygen and other gasses produced within the pipe structure of the present invention to escape into the atmosphere. Some embodiments of the inventive method further include utilizing sensors on the pipe structure of the present invention to ensure that the hydrogen collected and stored is purified and isolated from any other gas.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above present invention, and in the construction thereof, other than those specifically set forth herein, may be achieved by those skilled in the art without departing from the spirit and scope of the invention and that such changes modification or variations are to be considered as being within the overall scope of the present invention. Therefore, it is contemplated to cover the present invention and any and all changes, modifications, variations, or equivalents that fall within the true spirit and scope of the of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new, and useful results obtained; the new and useful structures, devices, elements, arrangements, parts and combination, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A system for the production of hydrogen and oxygen comprising:
(a) a hollow bell including an inlet and an outlet, wherein said inlet is configured to receive flowing water;
(b) an electrolysis device attached to said bell, said electrolysis device including an anode and a cathode;
(c) a hollow tube including a top end, a bottom end, and an interior volume extending therebetween, wherein said bottom end of said hollow tube is configured to connect to said outlet of said bell;
(d) at least one spicket connected to said hollow tube; and
(e) at least one collection tank, wherein said collection tank is configured to connect to said spicket.

2. The system of claim 1, wherein said inlet is further configured to receive water that is at a high pressure.

3. The system of claim 2, wherein said inlet is configured to receive water that is superheated.

4. The system of claim 3, wherein said inlet is configured to receive water in a supercritical phase.

5. The system of claim 1, wherein each spicket is configured to fill with one type of gas.

6. The system of claim 5, wherein each spicket further comprises a valve configured to open and close thereby controlling the flow of gas.

7. The system of claim 1, further comprising at least one membrane in said interior volume of said hollow tube, wherein said membrane includes a plurality of pores.

8. The system of claim 7, wherein said membrane divides said interior volume into a superior segments and inferior segment.

9. The system of claim 8, wherein said pores of said membrane are sized to permit hydrogen gas molecules to pass through said membrane from said inferior segment into said superior segment, while simultaneously preventing oxygen gas molecules from passing through said membrane, thereby remaining in said inferior segment.

10. The system of claim 1, further comprising at least one sensor located within said interior volume, wherein said sensor is configured to detect the presence of hydrogen gas.

11. A method of producing hydrogen gas, comprising:
(a) configuring a device to receive flowing water and separate hydrogen gas from the flowing water;
(b) locating a naturally occurring underwater source that expels flowing water;
(c) positioning said device to receive the flowing water from the naturally occurring underwater source; and
(d) collecting hydrogen gas from said device.

12. The method of claim 11, wherein the naturally occurring source of flowing water is a fissure expelling superheated water.

13. The method of claim 12, wherein the superheated water is expelled at a temperature greater than or equal to 374° C.

14. The method of claim 11, wherein the fissure is located more than 2,000 meters below the surface of the water, thereby expelling the water at a high pressure.

15. The method of claim 11, wherein the naturally occurring underwater source expels water in a supercritical phase.

16. The method of claim 11, wherein said device separates the hydrogen gas from the flowing water by way of electrolysis.

17. The method of claim 16, wherein the electrolysis is performed by providing direct current to an anode and cathode attached to said device.

18. A system for the production of hydrogen and oxygen comprising:
(a) a hollow bell including an inlet and an outlet, wherein said inlet is configured to receive flowing water;
(b) an electrolysis device attached to said bell, said electrolysis device configured to separate water into hydrogen and oxygen molecules;
(c) a hollow tube including a top end, a bottom end, and an interior volume extending therebetween, wherein said bottom end of said hollow tube is configured to connect to said outlet of said bell and receive hydrogen and oxygen molecules;
(d) at least one spicket connected to said hollow tube; and
(e) a collection tank connected to said spicket, said collection tank configured to collect hydrogen molecules.

19. The system of claim 18, wherein said inlet is further configured to receive water that is at a high pressure.

20. The system of claim 19, wherein said inlet is configured to receive water that is superheated.
